(19) United States
(12) Patent Application Publication
(10) Pub. No.: US 2026/0274190 A1
(43) Pub. Date: Sep. 17, 2026

(54) AIRBAG CUSHION AND FOLDING METHOD OF AIRBAG CUSHION

(71) Applicant: HYUNDAI MOBIS CO., LTD., Seoul (KR)

(72) Inventor: Sang Won HWANGBO, Yongin-si (KR)

(73) Assignee: HYUNDAI MOBIS CO., LTD., Seoul (KR)

(21) Appl. No.: 19/404,428

(22) Filed: Dec. 1, 2025

(30) Foreign Application Priority Data
Mar. 12, 2025 (KR) 10-2025-0032250

(51) Int. Cl. B60R 21/231; B60R 21/207; B60R 21/233; B60R 21/2338

(52) U.S. Cl. CPC B60R 21/23138; B60R 21/207; B60R 21/233; B60R 21/2338; B60R 2021/23146; B60R 2021/23386

(57) ABSTRACT

An airbag cushion includes an airbag to be folded at a seat and to wrap around sides and front of an occupant by being deployed outward from the seat during inflation and then unfolded forward, and capable of bending inward; and a shape retention member having a first end connected to the airbag and a second end connected to the seat, to allow a form of the inflated airbag wrapping the sides and front of the occupant to be maintained. The airbag is folded inward by a first folding amount when the shape retention member is folded inward, and folded outward by a second folding amount, and the shape retention member is folded to wrap the airbag in a direction opposite to a direction in which the airbag is folded by the second folding amount such that the second end of the shape retention member is positioned inward.

### CROSS REFERENCE TO THE RELATED APPLICATION

This application claims priority from Korean Patent Application No. 10-2025-0032250 filed on Mar. 12, 2025 in the Korean Intellectual Property Office, the disclosure of which is incorporated herein by reference in its entirety.

### BACKGROUND

### Field

The present disclosure relates to an airbag cushion and a folding method of the airbag cushion.

### Description of the Related Art

Generally, in the case of an omnidirectional airbag deployed in a shape that covers both the side surface and front surface of an occupant, a front chamber is connected to a side chamber to form an airbag cushion.

The airbag is folded on a side surface of a seatback and deployed toward the front of the occupant during a vehicle collision.

In the case of a conventional side airbag, the airbag is folded in an inboard folding manner in which the airbag is folded toward the occupant.

Since the side airbag has a relatively short front-rear length in the front-rear direction of the occupant, stable deployment can be achieved even if the front end of the airbag interferes with the shoulder of the occupant.

However, since the omnidirectional airbag has a relatively long front-rear length, if it is folded in the inboard folding manner like the side airbag, the airbag may be deployed between the back of the occupant and the seat, or may strongly push the shoulder of the occupant forward to cause injury to the occupant.

The matters described as the above background art are merely for enhancing understanding of the background of the present disclosure, and do not constitute an admission that they correspond to prior art already known to those having ordinary knowledge in this technical field.

### SUMMARY

The present disclosure is intended to provide an airbag cushion and a folding method of the airbag cushion in which the folding structure of the airbag cushion is improved so that the airbag is rapidly deployed to a proper position during deployment of the airbag, injury to the occupant due to the airbag striking the occupant is prevented, and the omnidirectional area of the occupant is safely protected by the airbag.

The technical problems to be achieved in the present disclosure are not limited to the technical problems mentioned above, and other technical problems not mentioned will be clearly understood by those having ordinary knowledge in the technical field to which the present invention belongs from the following description.

To achieve the above object, an airbag cushion according to the present disclosure includes an airbag configured to be folded at a seat and to wrap around sides and front of an occupant by being deployed outward from the seat during inflation and then unfolded forward, and configured to be capable of bending inward; and a shape retention member having a first end connected to the airbag and a second end connected to the seat, and configured to allow a form of the inflated airbag wrapping the sides and front of the occupant to be maintained. The airbag is folded inward by a first folding amount in a state in which the shape retention member is folded inward, and folded outward by a second folding amount, and the shape retention member is folded to wrap the airbag in a direction opposite to a direction in which the airbag is folded by the second folding amount such that the second end of the shape retention member is positioned inward.

According to one embodiment, the airbag is composed of a side chamber and a front chamber, wherein the side chamber is connected to the seat and configured to be deployed to a lateral side of the occupant, and wherein the front chamber is connected to the side chamber and configured to be deployed to the front of the occupant together with the side chamber during inflation.

According to one embodiment, the airbag may be folded in a tuck-in manner in which an end portion of the front chamber is pushed inward.

According to one embodiment, the side chamber comprises a first chamber portion mounted on the seat and connected to an inflator; a second chamber portion extended from the first chamber portion and matching with a side surface of the occupant during deployment; and a third chamber portion extended from the second chamber portion and to which the front chamber is connected; wherein during folding of the airbag, the first chamber portion is folded by the second folding amount, and the second chamber portion and the third chamber portion are folded by the first folding amount.

According to one embodiment, the first chamber portion may be folded in a zigzag manner to be deployed outward from the seat.

According to one embodiment, the second chamber portion may be folded to be rolled in an outward direction in a state in which the first chamber portion is unfolded.

According to one embodiment, the third chamber portion may be folded to be rolled in an inward direction in a state in which the second chamber portion is unfolded.

According to one embodiment, the first folding amount may be a length of the second chamber portion and the third chamber portion at a front of a shoulder area based on the shoulder area of the occupant.

According to one embodiment, the second folding amount may be a length of the first chamber portion at a rear of a shoulder area based on the shoulder area of the occupant.

According to one embodiment, the shape retention member comprises an upper tether and a lower tether, wherein the upper tether connects any one of an upper part of the side chamber or an upper part of the front chamber, or upper parts of respective chambers, to the seat, and wherein the lower tether connects any one of a lower part of the side chamber or a lower part of the front chamber, or upper parts of respective chambers, to the seat.

According to one embodiment, the upper tether comprises a first upper tether and a second upper tether, wherein the first upper tether connects the upper part of the side chamber to the seat, and the second upper tether connects the upper part of the front chamber to the seat.

According to one embodiment, the lower tether comprises a first lower tether and a second lower tether, wherein the first lower tether connects the lower part of the side chamber to the seat, and the second lower tether connects the lower part of the front chamber to the seat.

According to one embodiment, the airbag may be bent such that a portion thereof engages with the shape retention member in a state in which the shape retention member wraps the airbag and the second end of the shape retention member is positioned inward.

According to one embodiment, the portion of the airbag may be bent toward the front.

Meanwhile, a folding method of an airbag cushion according to the present disclosure comprises folding a shape retention member inward of an airbag; folding a portion of the shape retention member and the airbag inward by a first folding amount; folding the portion of the shape retention member and the airbag folded inward outward by a second folding amount; and making a remainder of the shape retention member positioned inward by wrapping the airbag in a direction opposite to a direction in which the airbag is folded by the second folding amount in a state in which the airbag is folded.

According to one embodiment, before or after folding the shape retention member inward of the airbag, the method may further comprise pushing a lower part of the airbag inward.

According to one embodiment, before folding the portion of the shape retention member and the airbag inward by the first folding amount, the method may further comprise pushing a part of the airbag that wraps a front surface of an occupant inward.

According to one embodiment, after making the remainder of the shape retention member positioned inward, the method may further comprise bending a portion of the airbag to engage with the shape retention member.

According to one embodiment, bending the portion of the airbag to engage with the shape retention member may comprise bending the portion of the airbag toward the front.

According to the airbag cushion and the folding method of the airbag cushion of the present disclosure, the folding structure of the airbag cushion is improved so that the airbag is rapidly deployed to a proper position during deployment of the airbag, injury to the occupant due to the airbag striking the occupant is prevented, and the omnidirectional area of the occupant is safely protected by the airbag.

The effects obtainable from the present disclosure are not limited to the effects mentioned above, and other effects not mentioned will be clearly understood by those having ordinary knowledge in the technical field to which the present disclosure belongs from the following description.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a state in which an airbag cushion according to an embodiment of the present disclosure is deployed to protect an occupant;

FIG. 2 is a view showing an airbag and a shape retention member according to an embodiment of the present disclosure;

FIG. 3 is a view showing a state in which an airbag cushion according to an embodiment of the present disclosure is unfolded before folding;

FIG. 4 is a view showing a folded state of an airbag cushion according to an embodiment of the present disclosure;

FIG. 5 is a view showing that a lower part of a second chamber portion of a side chamber is folded in a tuck-in manner in an airbag cushion according to an embodiment of the present disclosure;

FIG. 6 is a view showing that a shape retention member and a front chamber are folded in an airbag cushion according to an embodiment of the present disclosure;

FIG. 7 is a cross-sectional view of the airbag cushion shown in FIG. 6;

FIG. 8 is a view showing that a third chamber portion of a side chamber is folded in an airbag cushion according to an embodiment of the present disclosure;

FIG. 9 is a cross-sectional view of the airbag cushion shown in FIG. 8;

FIG. 10 is a view showing that a second chamber portion of a side chamber is folded in an airbag cushion according to an embodiment of the present disclosure;

FIG. 11 is a cross-sectional view of the airbag cushion shown in FIG. 10;

FIG. 12 is a view showing that a first chamber portion of a side chamber is folded in an airbag cushion according to an embodiment of the present disclosure;

FIG. 13 is a cross-sectional view of the airbag cushion shown in FIG. 12;

FIG. 14 is a view showing a state in which a shape retention member wraps an outer periphery of an airbag and is positioned inward in an airbag cushion according to an embodiment of the present disclosure; and

FIG. 15 is a flowchart of a folding method of an airbag cushion according to the present disclosure.

### DETAILED DESCRIPTION

In describing the embodiments disclosed in the present specification, detailed descriptions of related known technologies that may obscure the gist of the embodiments disclosed in the present specification are omitted when it is determined that they may obscure the gist. In addition, the accompanying drawings are merely for easy understanding of the embodiments disclosed in the present specification, and the technical ideas disclosed in the present specification are not limited by the accompanying drawings, and should be understood to include all changes, equivalents, or substitutes included in the spirit and technical scope of the present discourse. The following disclosure is not intended to limit the present disclosure to the described form or specific field, and it is considered that various alternative aspects and modifications of the present disclosure are possible, whether explicitly described or implied in the present specification. Those having ordinary knowledge in the technical field to which the present disclosure belongs will recognize that the form and details of the present disclosure content may be changed.

The present disclosure content is described with reference to specific aspects. However, as understood by those having ordinary skill in the technical field to which the present disclosure belongs, the various aspects disclosed in the present specification may be modified or otherwise implemented in various other ways without departing from the spirit and scope of the present disclosure content. Therefore, the following description should be considered as exemplary, and is for the purpose of teaching those having ordinary skill in the technical field to which the present disclosure belongs how to make and use various embodiments. It will be understood that the forms of the disclosure shown and described in the present specification will be taken as representative embodiments. Equivalent elements, or materials, processes or steps may be substituted for those representatively illustrated and described in the present disclosure. The expressions such as “including”, “comprising”, “incorporating”, “consisting of”, “have”, “is”, etc. used in describing the present disclosure should be interpreted in a non-exclusive manner, that is, allowing items, components or elements not explicitly described to be displayed. In addition, references to the singular should be interpreted as including those related to the plural.

In addition, the various embodiments disclosed in the present specification should be accepted in an exemplary and explanatory sense, and should not be interpreted as limiting the content of the present disclosure. All references to joining (for example, attached, affixed, coupled, connected, etc.) are used only to help understand the present disclosure, and do not limit the position, direction or use of the configuration or the methods disclosed in the present specification. Therefore, when joining references exist, they should be interpreted broadly. Moreover, in these joining references, it is not assumed that two or more elements are directly connected to each other. Additionally, all numerical terms, for example, “first”, “second”, “third”, “primary”, “secondary”, “main” or any other general terms or numerical terms should be taken only as identifiers to assist in understanding various components, forms, changes or variations of the present disclosure, and do not mean any limitations to any components, forms, changes or variations or their order or preference. That is, these expressions may be used to describe various components, but the components are not limited by these expressions. These expressions are used only for the purpose of distinguishing one component from another component.

The suffixes “module” and “unit” for components used in the following description are given or used interchangeably considering only the ease of writing the specification, and do not have meanings or roles that are distinguished from each other by themselves.

When a component is referred to as being “connected” or “coupled” to another component, it should be understood that it may be directly connected or connected to the other component, but other components may exist in between. On the other hand, when a component is referred to as being “directly connected” or “directly coupled” to another component, it should be understood that no other components exist in between.

Any number of components or various components in any of the configurations described in the present specification may be included within the disclosure described in the present specification. Components may include any combination of features described in the present specification and may be arranged in any of the various configurations described in the present specification. Concepts regarding the structure and arrangement of components of the present disclosure as well as their use and operation may be applied to any number of embodiments in any combination as well as the specific embodiments discussed in the present specification. Embodiments including those having various features of various arrangements are described below with reference to the drawings.

Hereinafter, various embodiments disclosed in the present specification will be described in detail with reference to the attached drawings, and the same or similar components will be given the same reference numbers regardless of drawing symbols, and overlapping descriptions thereof will be omitted.

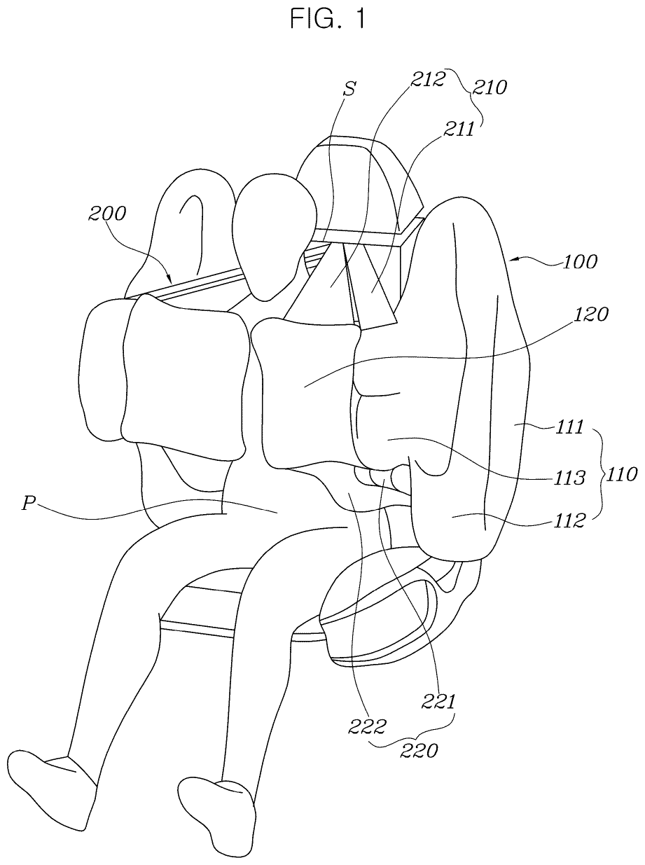

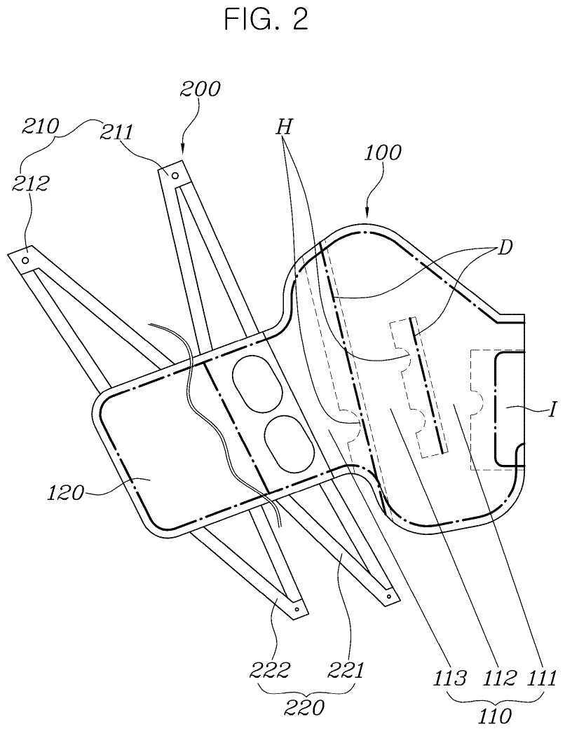

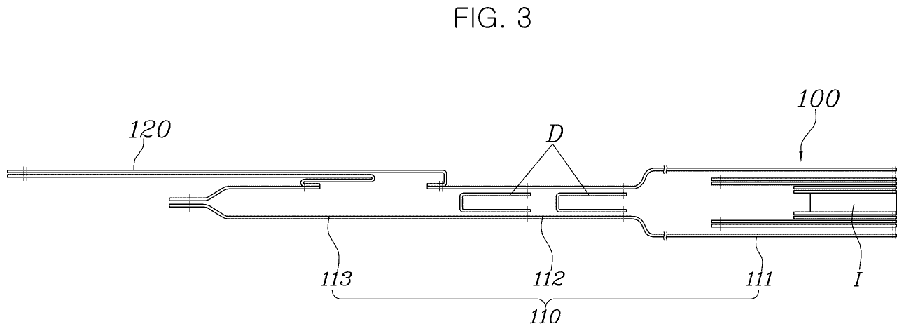

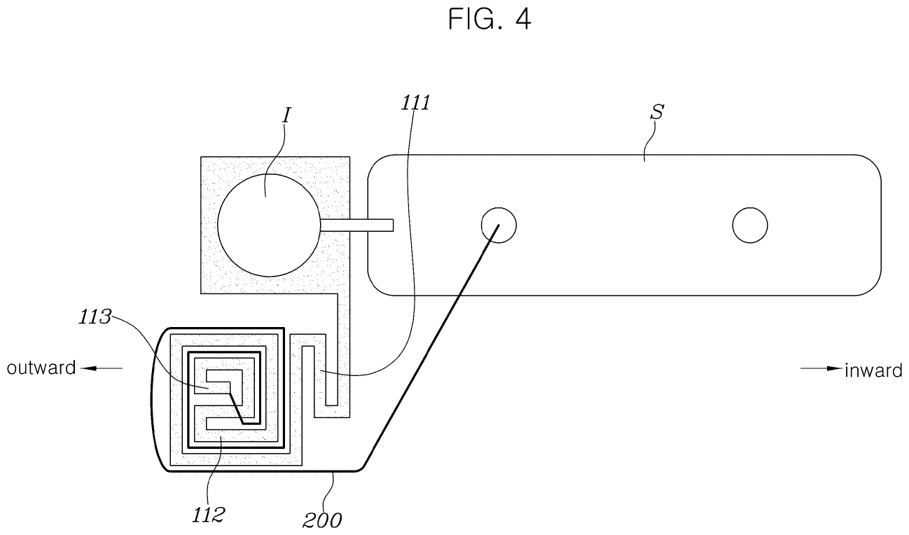

FIG. 1 is a view showing a state in which an airbag cushion according to an embodiment of the present disclosure is deployed to protect an occupant P, FIG. 2 is a view showing an airbag 100 and a shape retention member 200 according to an embodiment of the present disclosure, FIG. 3 is a view showing a state in which an airbag cushion according to an embodiment of the present disclosure is unfolded before folding, and FIG. 4 is a view showing a folded state of an airbag cushion according to an embodiment of the present disclosure.

As shown in FIG. 1, FIG. 2, FIG. 3 and FIG. 4, an airbag cushion according to the present disclosure may include an airbag 100 folded and disposed at a seat S, formed to wrap around sides and front of an occupant P by being deployed outward from the seat S during inflation, then unfolded forward, and formed to be capable of bending inward; and a shape retention member 200 having one end connected to the airbag 100 and other end connected to the seat S, allowing a form of the inflated airbag 100 wrapping the sides and front of the occupant P to be maintained.

The airbag cushion of the present disclosure is an omnidirectional airbag and may be provided at a side frame of the seat S.

The airbag 100 is installed on the seat S and may be deployed to protect the occupant P by being inflated by gas provided from an inflator I. The airbag 100 may have its shape determined by stitching fabric material.

The airbag 100 is prevented from interfering with the occupant P or striking the occupant P as it is deployed outward from the seat S, and unfolds from the lateral side of the occupant P to the front to protect the head, shoulder, chest, and pelvis of the occupant P, and the end portion thereof may be bent inward to wrap and restrain the occupant P.

The shape retention member 200 is connected to the airbag 100 and the seat S to maintain the shape of the inflated airbag 100. The shape retention member 200 may be made of fabric material. In addition, the shape retention member 200 may be formed to have a predetermined area to maintain the inflation form of the airbag 100 and secure its own robustness.

A plurality of shape retention members 200 may be provided, and may be connected to various parts of the airbag 100 such as parts requiring support force or parts requiring bending to maintain the inflation form of the airbag 100.

In particular, the present disclosure is configured with the airbag 100 formed to protect the sides and front of the occupant P and the shape retention member 200 for maintaining the form of the airbag 100, and secures the deployment speed of the airbag 100 through the folding structure of the airbag 100, prevents twisting of the shape retention member 200, and prevents interference with the deployment of the airbag 100 by the shape retention member 200.

That is, the airbag 100 is folded inward by a first folding amount in a state where the shape retention member 200 is folded inward, and then folded outward by a second folding amount, and the shape retention member 200 is folded to wrap the airbag 100 in a direction opposite to a direction in which the airbag 100 is folded by the second folding amount such that the other end is positioned inward.

In this way, the airbag 100 is folded with the shape retention member 200 folded inward during folding, so that twisting or interference by the shape retention member 200 can be prevented when the airbag 100 is inflated and deployed.

Thereafter, as the front end portion of the airbag 100 is folded inward together with the shape retention member 200, the airbag 100 can be deployed toward the front of the occupant P from the lateral side or front of the occupant P when the airbag 100 is inflated. At this time, the airbag 100 may be folded by the first folding amount. The first folding amount may be, for example, the length from the front end portion of the airbag 100 to the front part of the shoulder area of the occupant P when the airbag 100 is fully inflated.

In addition, as the front end portion of the airbag 100 is folded outward together with the shape retention member 200 in a state where it is folded inward, the initial deployment direction of the airbag 100 can be directed toward the outside of the seat S. Due to this, the airbag 100 can avoid interference with the seat S or the occupant P in the initial deployment. Here, the second folding amount may be, for example, the length from the rear end portion of the airbag 100 to the rear part of the shoulder area of the occupant P when the airbag 100 is fully inflated.

In the present disclosure, front-rear directions are based on the occupant, and inward or outward directions can be such that the seating space in the seat is inward, and the opposite direction is outward.

When the airbag 100 is folded in this way, the remainder of the shape retention member 200 exposed from the airbag 100 wraps the airbag 100 outward in a direction opposite to the direction folded by the second folding amount, so that the remainder of the shape retention member 200 can be positioned inward.

Due to this, as shown in FIG. 4, the shape retention member 200 has one end folded together with the airbag 100 and the other end positioned inward and connected to the seat S, so that interference between the airbag 100 and the shape retention member 200 during initial deployment of the airbag 100 is avoided, and the shape retention member 200 is unfolded along the deployment direction of the airbag 100 to normalize the deployment of the airbag 100 and regulate the position of the inflated airbag 100.

The above-described present disclosure will be specifically described as follows.

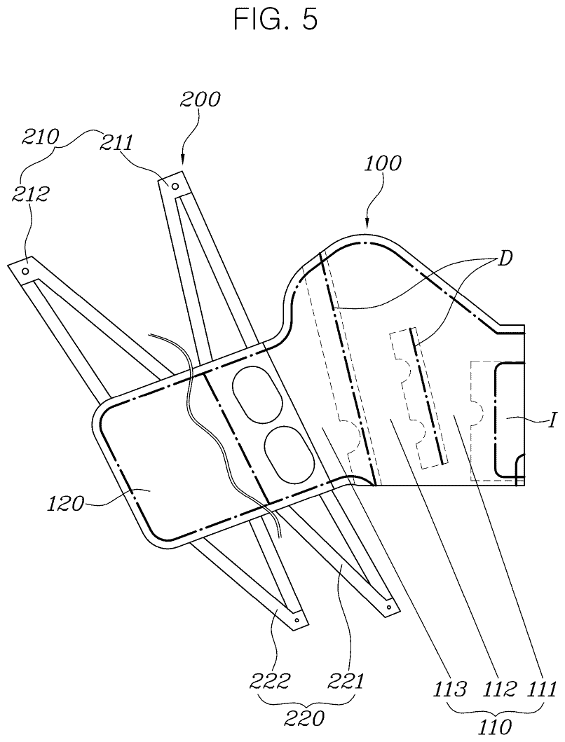

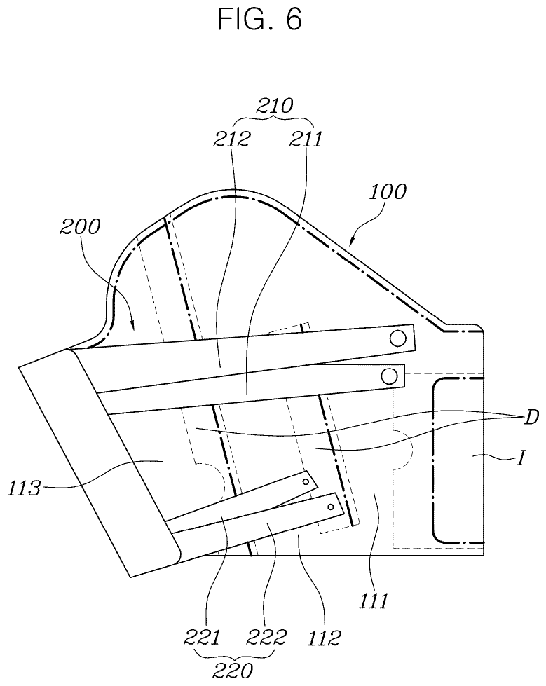

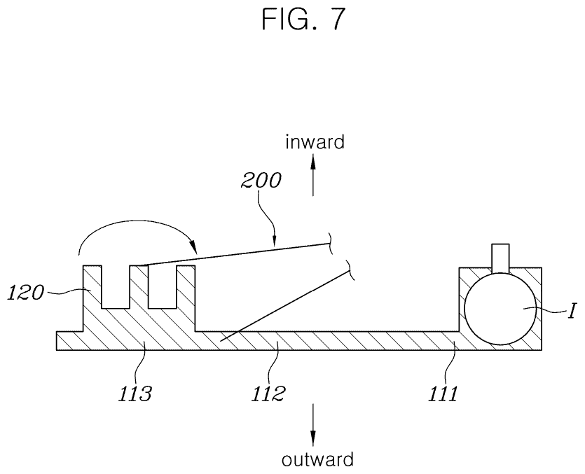

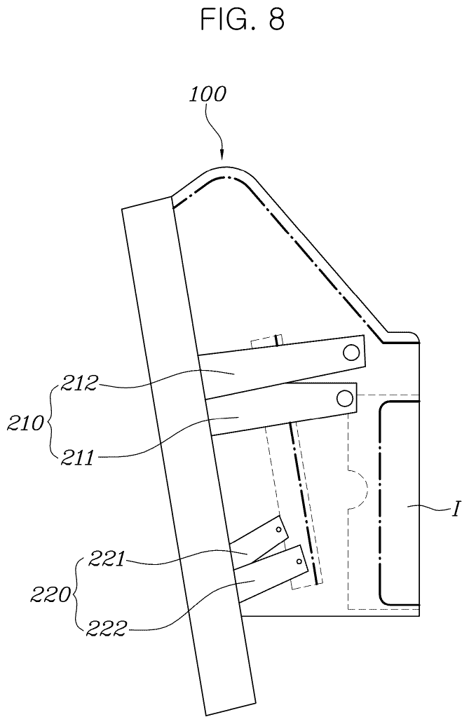

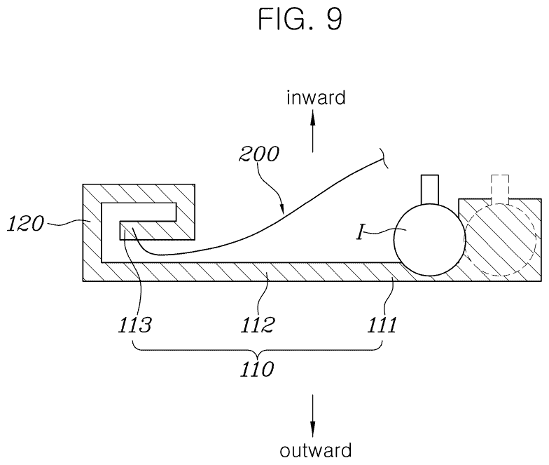

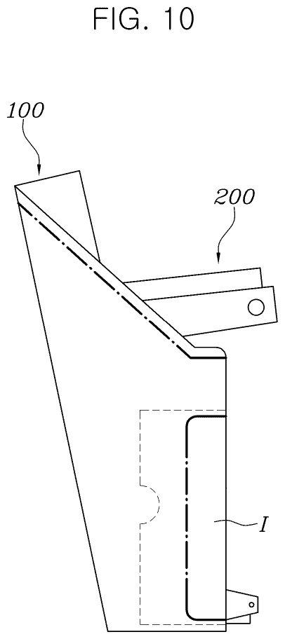

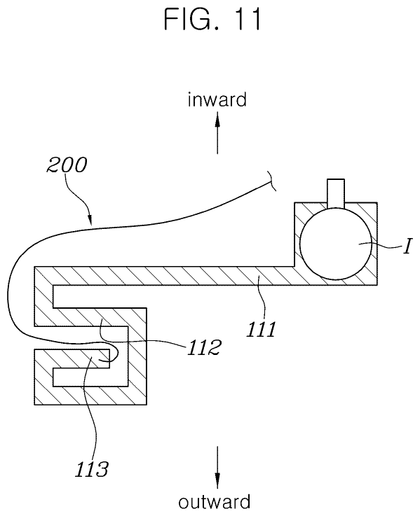

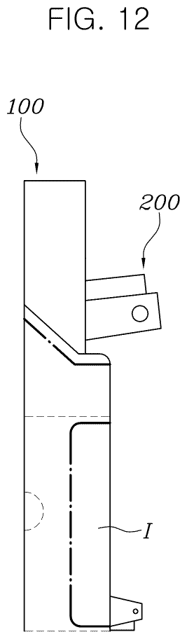

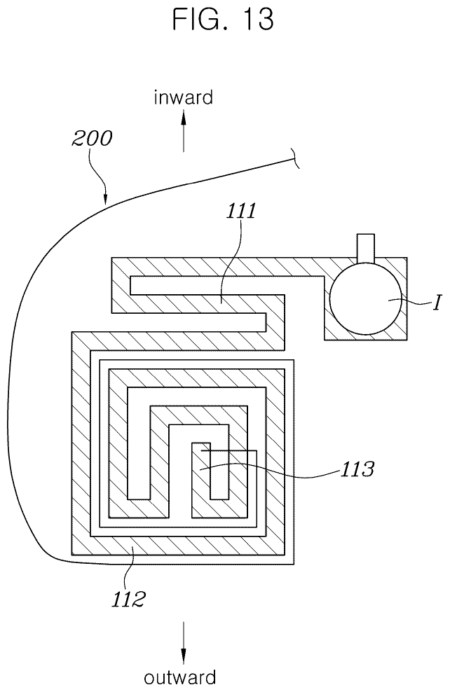

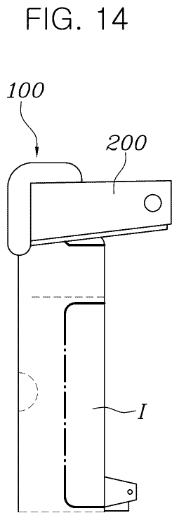

FIG. 5 is a view showing that a lower part of a second chamber portion 112 of a side chamber 110 is folded in a tuck-in manner in an airbag cushion according to an embodiment of the present disclosure, FIG. 6 is a view showing that a shape retention member 200 and a front chamber 120 are folded in an airbag cushion according to an embodiment of the present disclosure, and FIG. 7 is a cross-sectional view of the airbag cushion shown in FIG. 6. FIG. 8 is a view showing that a third chamber portion 113 of a side chamber 110 is folded in an airbag cushion according to an embodiment of the present disclosure, and FIG. 9 is a cross-sectional view of the airbag cushion shown in FIG. 8. FIG. 10 is a view showing that a second chamber portion 112 of a side chamber 110 is folded in an airbag cushion according to an embodiment of the present disclosure, and FIG. 11 is a cross-sectional view of the airbag cushion shown in FIG. 10. FIG. 12 is a view showing that a first chamber portion 111 of a side chamber 110 is folded in an airbag cushion according to an embodiment of the present disclosure, and FIG. 13 is a cross-sectional view of the airbag cushion shown in FIG. 12. In addition, FIG. 14 is a view showing a state in which a shape retention member 200 wraps an outer periphery of an airbag 100 and is positioned inward in an airbag cushion according to an embodiment of the present disclosure.

As shown in FIG. 2, the airbag 100 may be composed of a side chamber 110 and a front chamber 120.

Here, the side chamber 110 is connected to the seat S and formed to be deployed to a lateral side of the occupant P, and the front chamber 120 is connected to the side chamber 110 and formed to be deployed to the front of the occupant P during inflation together with the side chamber 110.

The side chamber 110 is installed on the seat S and may be formed to be deployed by gas pressure provided from the inflator I to protect the side surface of the occupant P. The side chamber 110 may protect the side surfaces of the head, shoulder, chest, and pelvis areas of the occupant P during deployment.

The front chamber 120 is connected to the side chamber 110, receives gas from the side chamber 110 to be inflated, and may be formed to protect the chest and abdomen front surfaces of the occupant P.

The front chamber 120 may be folded in a tuck-in manner in which an end portion thereof is pushed inward during folding of the airbag 100. That is, the front chamber 120 may be inserted to be pushed into the interior of the side chamber 110 and accommodated within the side chamber 110, and through this tuck-in folding, the front chamber 120 can be inflated after the side chamber 110 is inflated first, and the deployment of the side chamber 110 can be prevented from being interfered with by the front chamber 120.

Partitions D and holes H may be formed inside the side chamber 110 and the front chamber 120, and the inflation timing of the side chamber 110 and the front chamber 120 may be controlled through the partitions D, and the flow permission and direction of gas may be controlled through the holes H. In the airbag 100 structure, the partitions D and holes H may be applied in various forms.

Meanwhile, the side chamber 110 may include a first chamber portion 111 mounted on the seat S and connected to the inflator I; a second chamber portion 112 extended from the first chamber portion 111 and matching with a side surface of the occupant P during deployment; and a third chamber portion 113 extended from the second chamber portion 112 and to which the front chamber 120 is connected. The first chamber portion 111, the second chamber portion 112, and the third chamber portion 113 may be stitched and integrally formed.

Here, during folding of the airbag 100, the first chamber portion 111 is folded by the second folding amount, and the second chamber portion 112 and the third chamber portion 113 are folded by the first folding amount.

The first chamber portion 111 may be installed on a side frame of the seat S and receive gas from the inflator I. Accordingly, the first chamber portion 111 may be positioned at the rear of the airbag 100 based on the occupant P.

In addition, the first chamber portion 111 may be folded in a zigzag manner to be deployed outward from the seat S. Referring to FIG. 13, the first chamber portion 111 may be stacked multiple times in an outward direction of the seat S. Due to this, the first chamber portion 111 can be deployed to the lateral side of the shoulder of the occupant P during the inflation process.

In addition, the first chamber portion 111 may be folded by the second folding amount, which is the length of the first chamber portion 111 at the rear of the shoulder area based on the shoulder area of the occupant P. The second folding amount may be set, for example, as the length from the seat S to the shoulder area of the occupant P when the airbag 100 is fully inflated. Due to this, the first chamber portion 111 is deployed diagonally toward the outside and front based on the occupant P during inflation, and can be rapidly deployed to the shoulder area of the occupant P in a state where interference is avoided.

The second chamber portion 112 is folded to be rolled in an outward direction in a state where the first chamber portion 111 is unfolded, receives gas from the first chamber portion 111 to be inflated, and may be formed to extend vertically to protect the side surface of the occupant P. The occupant P protection range of the second chamber portion 112 may be formed to protect from the head to the pelvis of the occupant P.

Referring to FIG. 11, the second chamber portion 112 may be folded to be rolled outside the seat S. Due to this, the second chamber portion 112 can be deployed to be spaced apart from the occupant P during the inflation process, so that interference with the occupant P can be avoided.

The third chamber portion 113 may be folded to be rolled in an inward direction in a state where the second chamber portion 112 is unfolded. Referring to FIG. 9, the third chamber portion 113 receives gas from the second chamber portion 112 to be inflated, and the front chamber 120 is connected thereto. The third chamber portion 113 is rolled to face rearward inside the seat S, so that it can be deployed to the front of the occupant P during the inflation process and allow the front chamber 120 to be disposed on the front surface of the occupant P.

Here, the second chamber portion 112 and the third chamber portion 113 may be folded by the first folding amount, which is the length of the second chamber portion 112 and the third chamber portion 113 at the front of the shoulder area based on the shoulder area of the occupant P. The first folding amount may be set, for example, as the length from the end of the third chamber portion 113 to the shoulder area of the occupant P when the airbag 100 is fully inflated. Due to this, the second chamber portion 112 and the third chamber portion 113 avoid interference with the occupant P during inflation and can be rapidly deployed past the shoulder area of the occupant P.

In this way, when the front chamber 120 and the side chamber 110 of the airbag 100 are folded, the shape retention member 200 is positioned outside the airbag 100 as shown in FIG. 12, and when the shape retention member 200 is wound forward again to wrap the airbag 100, the other end of the shape retention member 200 can be positioned inward. Due to this, even if the shape retention member 200 is connected to the seat S, interference with the deployment of the airbag 100 can be avoided as shown in FIG. 4.

In addition, as shown in FIG. 14, a portion of the airbag 100 above the shape retention member 200 can be bent to engage with the shape retention member 200 so that the airbag 100 does not detach from the shape retention member 200. At this time, the portion of the airbag 100 may be bent toward the front.

That is, if the shape retention member 200 is pushed away from the airbag 100 by the inflating force during inflation of the airbag 100, twisting of the shape retention member 200 may occur or interference with the inflation of the airbag 100 may occur. Therefore, the portion of the airbag 100 is bent forward to engage with the shape retention member 200, so that interference with the seat S or the occupant P including the periphery can be avoided when the bent portion is inflated.

Meanwhile, the shape retention member 200 may include an upper tether 210 and a lower tether 220.

The upper tether 210 connects any one of an upper part of the side chamber 110 or an upper part of the front chamber 120, or upper parts of respective chambers, to the seat S, and the lower tether 220 connects any one of a lower part of the side chamber 110 or a lower part of the front chamber 120, or upper parts of respective chambers, to the seat S.

In this way, the upper tether 210 and the lower tether 220 are respectively connected to the upper and lower parts of the airbag 100 to provide tension from the seat S, so that the inflation shapes of the side chamber 110 and the front chamber 120 can be maintained in a form capable of protecting the occupant P.

The upper tether 210 and the lower tether 220 may be made of fabric material and may include stretchable elastic material. In addition, the upper tether 210 and the lower tether 220 may have their bonding width, position, length, etc. set according to the deployment shape of the airbag 100.

In detail, the upper tether 210 may include a first upper tether 211 and a second upper tether 212.

The first upper tether 211 connects the upper part of the side chamber 110 to the seat S, and the second upper tether 212 connects the upper part of the front chamber 120 to the seat S.

That is, one end of the first upper tether 211 may be stitched to the upper part of the side chamber 110 and the other end may be coupled to the seat S, and the width of one end may be formed larger than the width of the other end. The first upper tether 211 allows the side chamber 110 to be disposed on the side surface of the occupant P, and regulates the inflation form and position so that the side surface of the occupant P is protected.

One end of the second upper tether 212 may be stitched to the upper part of the front chamber 120 and the other end may be coupled to the upper part of the seat S, and the width of one end may be formed larger than the width of the other end. The second upper tether 212 is disposed so as not to interfere with the neck of the occupant P during deployment of the airbag 100, and allows the front chamber 120 to be bent in a direction wrapping the occupant P so that the front chamber 120 protects and restrains the occupant P.

The lower tether 220 may include a first lower tether 221 and a second lower tether 222.

The first lower tether 221 connects the lower part of the side chamber 110 to the seat S, and the second lower tether 222 connects the lower part of the front chamber 120 to the seat S.

One end of the first lower tether 221 may be stitched to the lower part of the side chamber 110 and the other end may be coupled to the lower part of the seat S, and the width of one end may be formed larger than the width of the other end. The first lower tether 221 allows the side chamber 110 to be disposed on the side surface of the occupant P, and regulates the inflation form and position so that the side surface of the occupant P is protected.

One end of the second lower tether 222 may be stitched to the lower part of the front chamber 120 and the other end may be coupled to the lower part of the seat S, and the width of one end may be formed larger than the width of the other end. The second lower tether 222 is disposed so as not to interfere with the pelvis or waist of the occupant P during deployment of the airbag 100, and allows the front chamber 120 to be bent in a direction wrapping the occupant P so that the front chamber 120 protects and restrains the occupant P.

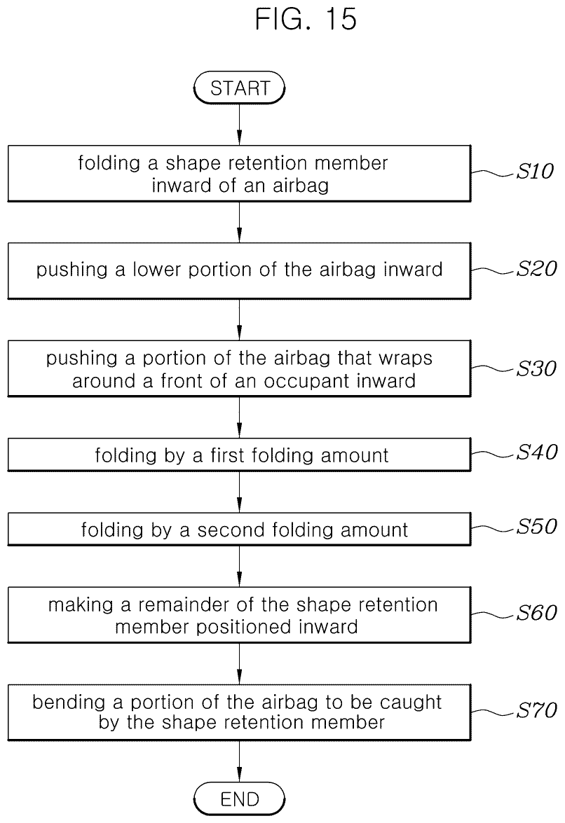

A folding method of an airbag cushion according to the present disclosure includes, as shown in FIG. 15, folding a shape retention member 200 inward of an airbag 100 in step S10; folding a portion of the shape retention member 200 and the airbag 100 inward by a first folding amount in step S40; folding the portion of the shape retention member 200 and the airbag 100 folded inward outward by a second folding amount in step S50; and making a remainder of the shape retention member 200 positioned inward by wrapping the airbag 100 in a direction opposite to a direction in which the airbag 100 is folded by the second folding amount in a state where the airbag 100 is folded in step S60.

Here, before or after folding the shape retention member 200 inward of the airbag 100 in step S10, the method may further include pushing a lower part of the airbag 100 inward in step S20.

In addition, before folding the portion of the shape retention member 200 and the airbag 100 inward by the first folding amount in step S40, the method may further include pushing inward a part of the airbag 100 that wraps a front surface of the occupant P in step S30.

In addition, after making the remainder of the shape retention member 200 positioned inward in step S60, the method may further include bending a portion of the airbag 100 to engage with the shape retention member 200 in step S70.

Here, bending the portion of the airbag 100 to engage with the shape retention member 200 in step S70 can bend the portion of the airbag 100 toward the front.

The folding method of the airbag 100 will be described with reference to the drawings as follows.

FIG. 2 shows a state where the airbag 100 and the shape retention member 200 are unfolded.

Here, as shown in FIG. 5, tuck-in folding is performed by inserting the lower part of the side chamber 110 inward in the airbag 100. Due to this, the overall size can be reduced when folding the airbag cushion, and the lower part can be deployed after the side chamber 110 is unfolded forward.

Thereafter, as shown in FIGS. 6 to 7, the front chamber 120 is folded in a tuck-in manner by pushing it inward in the airbag 100, and the shape retention member 200 is folded inward of the airbag 100. In this way, when the front chamber 120 is folded in a tuck-in manner, the front chamber 120 can be deployed after the side chamber 110 is completely unfolded. In addition, by positioning the shape retention member 200 inward of the airbag 100, the airbag 100 can be maintained in a form supported toward the occupant P side in a state connected to the seat S.

Thereafter, as can be seen in FIGS. 8 to 9, the airbag 100 is rolled and folded inward by the second folding amount in an inward direction. Here, the second folding amount may be, for example, the length from the rear end portion of the airbag 100 to the rear part of the shoulder area of the occupant P when the airbag 100 is fully inflated. In this way, by rolling the second chamber portion 112 and the third chamber portion 113 inward in the side chamber 110 of the airbag 100, the second chamber portion 112 and the third chamber portion 113 can be deployed toward the front in front of the occupant P during inflation of the airbag 100.

Thereafter, as can be seen in FIGS. 10 to 11, the part rolled inward in the airbag 100 can be rolled and folded outward by the first folding amount. Here, the first folding amount may be, for example, the length from the front end portion of the airbag 100 to the front part of the shoulder area of the occupant P when the airbag 100 is fully inflated. Due to this, the airbag 100 can be deployed outward, which is a direction away from the occupant P, during inflation, so that striking or interfering with the occupant P can be avoided.

Thereafter, as can be seen in FIGS. 12 to 13, the part rolled outward and inward in the airbag 100 can be folded in a zigzag manner toward the outside. Through this zigzag folding, the initial deployment direction of the airbag 100 during inflation can be set outward, which is a direction away from the seat S.

In this way, after folding the airbag 100, as shown in FIG. 14, the shape retention member 200 positioned outside is rotated forward again to wrap the airbag 100, positioning the other end of the shape retention member 200 inward. In addition, a portion of the airbag 100 above the shape retention member 200 can be bent to engage with the shape retention member 200 so that the airbag 100 does not detach from the shape retention member 200. At this time, the portion of the airbag 100 may be bent toward the front. Due to this, the shape retention member 200 is prevented from being pushed away from the airbag 100 by the inflating force during inflation of the airbag 100, and twisting of the shape retention member 200 or interference with the inflation of the airbag 100 can be avoided.

In addition, since the portion of the airbag 100 is bent forward to engage with the shape retention member 200, interference with the seat S or the occupant P including the periphery can be avoided when the bent portion is inflated.

According to the airbag cushion and the folding method of the airbag cushion of the present disclosure, the folding structure of the airbag cushion is improved so that the airbag is rapidly deployed to a proper position during deployment of the airbag, injury to the occupant due to the airbag striking the occupant is prevented, and the omnidirectional area of the occupant is safely protected by the airbag.

Although shown and described with respect to specific embodiments of the present disclosure, it is obvious to those having ordinary knowledge in the technical field to which the present disclosure belongs that the present disclosure can be variously improved and changed without departing from the technical spirit of the present disclosure provided by the following claims.

What is claimed is:

1. An airbag cushion comprising:
an airbag configured to be folded at a seat and to wrap around sides and front of an occupant by being deployed outward from the seat during inflation and then unfolded forward, and configured to be capable of bending inward; and
a shape retention member having a first end connected to the airbag and a second end connected to the seat, and configured to allow a form of the inflated airbag wrapping the sides and front of the occupant to be maintained;
wherein the airbag is folded inward by a first folding amount in a state in which the shape retention member is folded inward, and folded outward by a second folding amount, and
wherein the shape retention member is folded to wrap the airbag in a direction opposite to a direction in which the airbag is folded by the second folding amount such that the second end of the shape retention member is positioned inward.

2. The airbag cushion of claim 1, wherein the airbag includes a side chamber and a front chamber,
wherein the side chamber is connected to the seat and configured to be deployed to a lateral side of the occupant, and
wherein the front chamber is connected to the side chamber and configured to be deployed to the front of the occupant together with the side chamber during inflation.

3. The airbag cushion of claim 2, wherein the airbag is folded in a tuck-in manner in which an end portion of the front chamber is pushed inward.

4. The airbag cushion of claim 2, wherein the side chamber comprises:
a first chamber portion mounted on the seat and connected to an inflator;
a second chamber portion extended from the first chamber portion and matching with a side surface of the occupant during deployment; and
a third chamber portion extended from the second chamber portion and to which the front chamber is connected;
wherein during folding of the airbag, the first chamber portion is folded by the second folding amount, and the second chamber portion and the third chamber portion are folded by the first folding amount.

5. The airbag cushion of claim 4, wherein the first chamber portion is folded in a zigzag manner to be deployed outward from the seat.

6. The airbag cushion of claim 4, wherein the second chamber portion is folded to be rolled in an outward direction in a state in which the first chamber portion is unfolded.

7. The airbag cushion of claim 4, wherein the third chamber portion is folded to be rolled in an inward direction in a state in which the second chamber portion is unfolded.

8. The airbag cushion of claim 4, wherein the first folding amount is a length of the second chamber portion and the third chamber portion at a front of a shoulder area of the occupant based on the shoulder area.

9. The airbag cushion of claim 4, wherein the second folding amount is a length of the first chamber portion at a rear of a shoulder area of the occupant based on the shoulder area.

10. The airbag cushion of claim 2, wherein the shape retention member comprises an upper tether and a lower tether,
wherein the upper tether connects any one of an upper part of the side chamber or an upper part of the front chamber, or upper parts of respective chambers, to the seat, and
wherein the lower tether connects any one of a lower part of the side chamber or a lower part of the front chamber, or upper parts of respective chambers, to the seat.

11. The airbag cushion of claim 10, wherein the upper tether comprises a first upper tether and a second upper tether,
wherein the first upper tether connects the upper part of the side chamber to the seat, and the second upper tether connects the upper part of the front chamber to the seat.

12. The airbag cushion of claim 10, wherein the lower tether comprises a first lower tether and a second lower tether,
wherein the first lower tether connects the lower part of the side chamber to the seat, and the second lower tether connects the lower part of the front chamber to the seat.

13. The airbag cushion of claim 1, wherein the airbag is bent such that a portion thereof engages with the shape retention member in a state in which the shape retention member wraps the airbag and the second end of the shape retention member is positioned inward.

14. The airbag cushion of claim 13, wherein the portion of the airbag is bent toward the front.

15. A folding method of an airbag cushion, the method comprising:
folding a shape retention member inward of an airbag;
folding a portion of the shape retention member and the airbag inward by a first folding amount;
folding the portion of the shape retention member and the airbag folded inward outward by a second folding amount; and
making a remainder of the shape retention member positioned inward by wrapping the airbag in a direction opposite to a direction in which the airbag is folded by the second folding amount in a state in which the airbag is folded.

16. The folding method of claim 15, further comprising, before or after folding the shape retention member inward of the airbag:
pushing a lower part of the airbag inward.

17. The folding method of claim 15, further comprising, before folding the portion of the shape retention member and the airbag inward by the first folding amount:
pushing a part of the airbag that wraps a front surface of an occupant inward.

18. The folding method of claim 15, further comprising, after making the remainder of the shape retention member is positioned inward,
bending a portion of the airbag to engage with the shape retention member.

19. The folding method of claim 18, wherein bending the portion of the airbag to engage with the shape retention member comprises bending the portion of the airbag toward the front.
